(19) United States
(12) Patent Application Publication
(10) Pub. No.: US 2015/0285275 A1
(43) Pub. Date: Oct. 8, 2015

(54) HYDRAULIC LINEAR ACTUATOR INTEGRATED INTO A FLEXIBLE HOSE, AND HYDRAULIC CIRCUIT USING SAME

(71) Applicant: Caterpillar Inc., Peoria, IL (US)

(72) Inventor: Carl Rempert, Shorewood, IL (US)

(73) Assignee: Caterpillar Inc., Peoria, IL (US)

(21) Appl. No.: 14/243,240

(22) Filed: Apr. 2, 2014

(51) Int. Cl. F15B 15/14; F15B 11/08; F15B 1/26

(52) U.S. Cl. CPC F15B 15/149; F15B 1/26; F15B 11/08; F15B 2201/00; F15B 2211/205; F15B 2211/3105; F15B 2211/7052

(57) ABSTRACT

A hydraulic hoselinder is a hydraulic linear actuator integrated into a flexible hose. A continuous length of flexible hose has a rigid fluid coupling mounted at one end and a rigid rod fitting mounted at an opposite end. A cylinder rod extends through the rigid rod fitting and includes an eye at one end and a piston that divides the flexible hose into a extend hydraulic volume and a retract volume. The cylinder rod is movable along a straight line with respect to the rigid rod fitting between a refracted position and an extended position. A majority of the active length of cylinder rod is positioned inside and outside of the flexible hose at the retracted and extended positions, respectively.

### TECHNICAL FIELD

The present disclosure relates generally to hydraulic linear actuators, and more particularly to integration of a hydraulic linear actuator into a flexible hydraulic hose.

### BACKGROUND

Hydraulic cylinders have long been used as linear actuators in a wide variety of different applications. A typical hydraulic circuit includes a hydraulic pump that can be used to supply pressurized hydraulic fluid to one side or another of a piston that is attached to a rod to lengthen or shorten the hydraulic cylinder to perform some task. Hydraulic cylinders are generally robust, expensive, and have a long life span provided that internal seals are replaced when worn or broken. Unfortunately, the high cost associated with hydraulic cylinders often renders them unsuitable for lighter duty linear actuator applications that demand lower costs.

The present disclosure is directed toward one or more of the problems set forth above.

### SUMMARY

A hydraulic hoselinder comprises a hydraulic linear actuator integrated into a flexible hose. The flexible hose has a rigid fluid coupling mounted to one end with a first crimp collar, and a rigid rod fitting mounted to an opposite end with a second crimp collar. A cylinder rod extends through the rigid rod fitting and includes an eye at one end and a piston that divides the flexible hose into an extend hydraulic volume and a retract volume. The cylinder rod is movable along a straight line with respect to the rigid rod fitting between a retracted position and an extended position. The rigid fluid coupling is located a distance from the rigid rod fitting along a central axis of the flexible hose, and the distance is greater than a length of the cylinder rod. A majority of the length of the cylinder rod is positioned inside the flexible hose at the retracted position, and a majority of the length of the cylinder rod is positioned outside the flexible hose at the extended position.

In another aspect, a hydraulic system includes a hydraulic fluid pump with an inlet fluidly connected to a tank of hydraulic fluid. A hydraulic circuit has one end fluidly connected to an outlet of the hydraulic fluid pump, and a second end opening back into the tank. A control valve is positioned in the hydraulic circuit and is movable among a retract configuration, a neutral configuration and an extend configuration. A hydraulic hoselinder has a rigid fluid coupling fluidly connected to the hydraulic circuit, and includes a hydraulic linear actuator integrated into a flexible hose. The flexible hose has the rigid fluid coupling mounted to one end with a first crimp collar and a rigid rod fitting mounted to an opposite end with a second crimp collar. A cylinder rod extends through the rigid rod fitting and includes an eye at one end and a piston that divides the flexible hose into an extend hydraulic volume and a retract volume. The cylinder rod is movable along a straight line with respect to the rigid rod fitting between a retracted position and an extended position. The rigid fluid coupling is located a distance from the rigid rod fitting along a central axis of the flexible hose, and the distance is greater than a length of the cylinder rod. A majority of the length of the cylinder rod is positioned inside the flexible hose at the retracted position, and a majority of the length of the cylinder rod is positioned outside the flexible hose at the extended position.

### BRIEF DESCRIPTION OF THE DRAWINGS

FIG. 1 is a schematic of a hydraulic system according to one aspect of the present disclosure;

FIG. 2 is a sectioned side view of the hydraulic hoselinder from the hydraulic circuit of FIG. 1;

FIG. 3 is an end view of the rigid rod fitting for the hydraulic hoselinder of FIG. 2;

FIG. 4 is a partial sectioned side view of a hydraulic hoselinder according to another embodiment of the present disclosure;

FIG. 5 is a partial sectioned side view of a hydraulic hoselinder according to still another embodiment of the present disclosure; and

FIG. 6 is a sectioned side view of a hydraulic hoselinder according to another aspect of the present disclosure.

### DETAILED DESCRIPTION

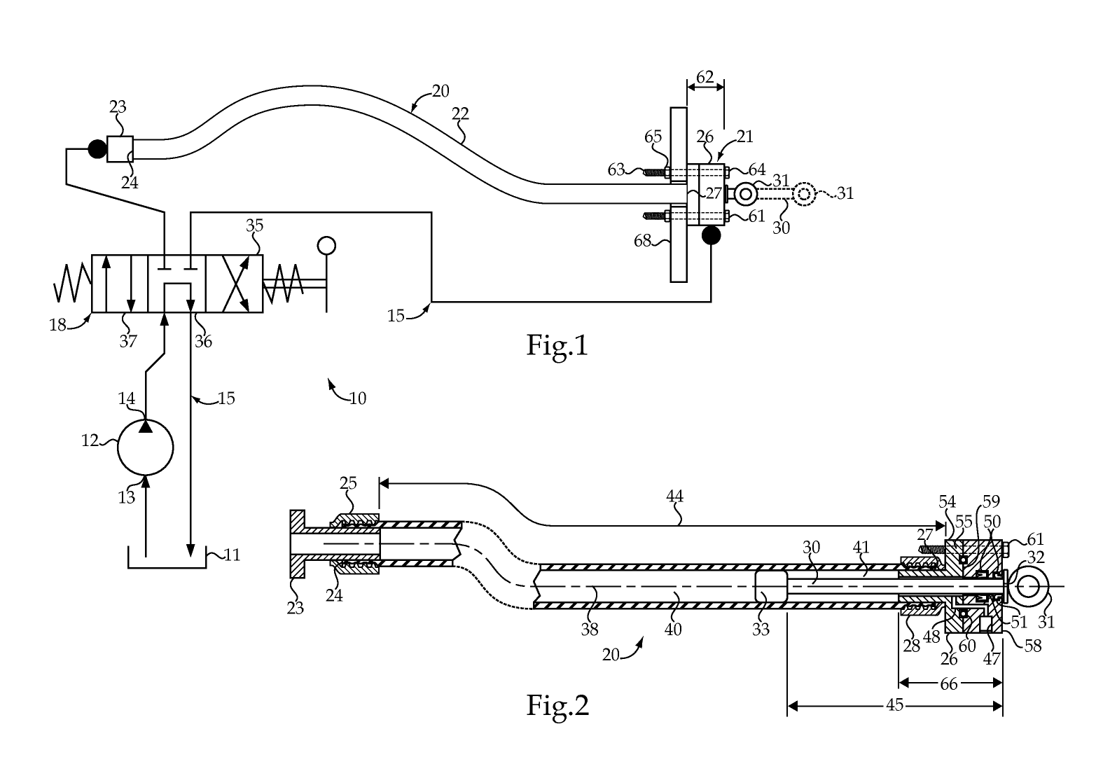

Referring initially to FIG. 1, a hydraulic system 10 includes a tank 11 of hydraulic fluid. A hydraulic fluid pump 12 has an inlet 13 fluidly connected to the tank 11. A hydraulic circuit 15 has one end fluidly connected to an outlet 14 of the hydraulic fluid pump 12 and a second end opening back into tank 11. A control valve 18 is positioned in the hydraulic circuit 15 and is movable among a retract configuration 35, a neutral configuration 36 (as shown) and an extend configuration 37. As per many hydraulic control valves well known in the art, the control valve 18 is biased toward the neutral configuration 36 in which all of the fluid generated by hydraulic fluid pump 12 is returned to tank 11. Also shown in FIG. 1 is a hydraulic hoselinder 20 fluidly connected to hydraulic circuit 15 and attached to a mounting bracket 68, which can be thought of as a part of a machine (not shown) that includes hydraulic system 10. Hydraulic hoselinder 20 can be thought of as a hydraulic linear actuator 21 integrated into a flexible hose 22.

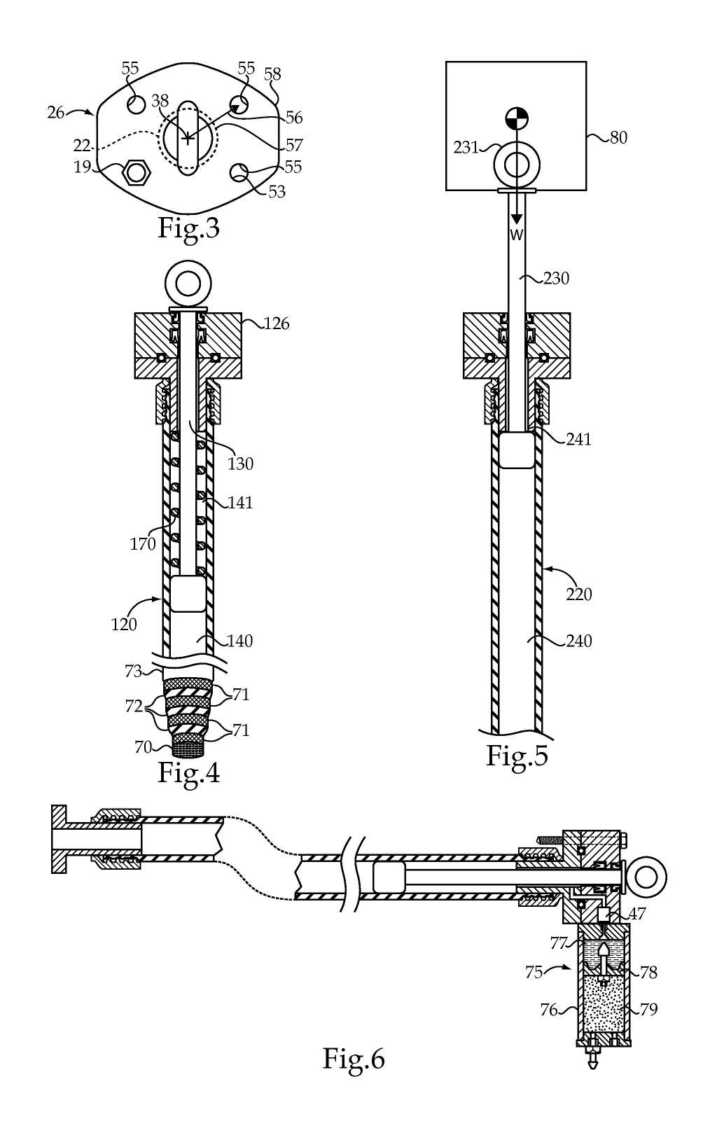

Referring now in addition to FIGS. 2 and 3, the flexible hose 22 of hydraulic hoselinder 20 has a rigid fluid coupling 23 mounted to one end 24 with a first crimp collar 25, and a rigid rod fitting 26 mounted to an opposite end 27 with a second crimp collar 28. Each of the crimp collars may include several annular crimp barbs 29 that serve to better grip the exterior surface of the flexible hose 22 at the attachment to the respective fitting 23, 26. Flexible hose 22 is continuous between ends 24 and 27. Continuous means the absence of discontinuities. In other words, flexible hose 22 has always been a single continuous segment of hose free of any connection joints, such that the hose was originally manufactured as a single segment. As used in the present disclosure, rigid components are made from metal or another suitable material that, by design, remains rigid during proper usage. As used in the present disclosure, a flexible hose means a hose constructed of flexible material, such as rubber or a related compound, and re-enforcements such as metal or fiber spiral weaves that allow the hose to flex while holding pressure during its normal usage. In particular, the term flexible hose refers to any of the wide variety of flexible hoses currently utilized in the hydraulic industry. A flexible hose is neither a hydraulic cylinder, which is a well known linear actuator, nor is it a rigid hydraulic tube often utilized in hydraulic systems for constructing portions of a hydraulic circuit. Hydraulic systems according to the prior art often include rigid hydraulic tubing, flexible hoses and hydraulic cylinders. The hydraulic hoselinder 20 of the present disclosure replaces the hydraulic cylinder associated with hydraulic systems of the prior art. Thus, hydraulic circuit 15 may include both rigid hydraulic tubing and other segments of flexible hose apart from flexible hose 22.

Referring now in addition to FIGS. 2 and 3, rigid fluid coupling 23 and rigid rod fitting 26 are attached to flexible hose 22 using conventionally available crimping components and techniques that are well known in the art. A cylinder rod 30 extends through the rigid rod fitting 26 and includes an eye 31 at one end 32, and a piston 33 that divides the flexible hose into an extend hydraulic volume 40 and a retract volume 41. Piston 33 may include seals and/or a wear band in the clearance area between the exterior surface of piston 33 and the inner surface of flexible hose 22 in order to provide the hydraulic hoselinder 20 with appropriate sealing and wear characteristics. On the other hand, the interior surface of flexible hose 22 may function as a wear surface and sealing surface permitting the possible use of a piston 33 without a wear band and/or seals. The cylinder rod 30 is constrained by the rigid rod fitting to move along a straight line with respect to the rigid rod fitting 26 between a refracted position and an extended position, which is shown by a dotted line in FIG. 1. The rigid fluid coupling 23 is located a distance 44 from the rigid rod fitting 26 along a central axis 38 of the flexible hose 22, and the distance is greater than a length 45 of the cylinder rod 30. A majority of active length of the cylinder rod 30 is positioned inside the flexible hose 22 at the refracted position, and a majority of the active length of the cylinder rod 30 is positioned outside the flexible hose 22 at the extended position. For purposes of the present disclosure, active length equals total length 45 minus a rod fitting length 66 (FIG. 2).

In the case of the embodiment shown in FIGS. 1-3, the retract volume is a retract hydraulic volume 41. As such, the rigid rod fitting 26 includes a retract port 47 fluidly connected to the retract hydraulic volume 41 through a passage 48 defined by the rigid rod fitting 26. In the illustrated embodiment, the retract port is defined by the end cap 58, but could equally be defined by the end fitting 54 without departing from the scope of the present disclosure. A set of hydraulic cylinder seals 50 may be positioned in an annular clearance 51 between the cylinder rod 30 and rigid rod fitting 26. In the illustrated embodiment, this set of hydraulic seals 50 may include a U-cup seal and a wiper seal of conventional shape and made from materials well known in the art. Although rigid rod fitting 26 could take a wide variety of forms without departing from the present disclosure, in the illustrated embodiment, rigid rod fitting 26 includes an end fitting 54 that defines a plurality of fastener bores 55 that extend parallel to the central axis 38 at a distance 56 that is greater than an outer diameter 57 of the flexible hose 22. An end cap 58, which is also part of rigid rod fitting 26 is in contact with the end fitting 54 in a plane 59 oriented perpendicular to central axis 38, and also includes a plurality of fastener bores 53 that align with the plurality of fastener bores 55 of the end fitting 54. A face seal 60 is positioned between, and in contact with, the end fitting 54 and the end cap 58. A bolt 61 extends through each pair of the aligned fastener bores 53,55. It may be desirable for one, but not both, of the end fitting 54 and the end cap 58 to have threads to match the bolt 61. If this option is chosen, the bolts 61 can serve to hold end fitting 54 to end cap 58. If the bolt 61 is longer than a combined length 62 of the end fitting 54 and end cap 58, a threaded segment 63 of the bolt may extend beyond one of the end fitting 54 and the end cap 58 when a head 64 of the bolt 61 is in contact with the other of the end fitting 54 and the end cap 58. In the illustrated example, the fastener bores 55 of the end cap 54 may be threaded so that the bolt holds the end fitting 54 to the end cap 58, and the threaded segment 63 that extends beyond the end fitting 54 allows the rigid rod fitting 26 (and hence the hoselinder 20) to be mounted to a suitable mounting bracket 68, or the like of a machine, with a separate nut 65 that is threaded onto threaded segment 63 as best shown in FIG. 1.

Although the hydraulic hoselinder 20 previously described utilizes hydraulic fluid to both extend and retract the cylinder rod 30 via fluid forces on piston 33, the present disclosure also contemplates other strategies to facilitate retraction of cylinder rod 30. For instance, FIG. 4 illustrates a hydraulic hoselinder 120 in which a biasing spring 170 is positioned in retract volume 141. Spring 170 biases the cylinder rod 130 toward its retracted position, as shown. If the hydraulic hoselinder 120 of FIG. 4 were substituted in place of the hydraulic hoselinder 20 in FIG. 1, the retract volume 141 would have no fluid connection to hydraulic circuit 15, and instead rely upon spring 170 to facilitate retraction of the cylinder rod 130 as opposed to hydraulic force as in the embodiments shown in FIGS. 1-3. FIG. 4 is also of interest for showing the different layers that may appear in a flexible hose 22 according to the present disclosure. For instance, the flexible hose 22 may include a reinforcing fabric 70 that is part of a low compression set liner surrounded by several alternating layers of spiral wound wire weave 71 and rubber cushion layers 72. Finally, the flexible hose may include a oil and abrasion resistant cover 73. Those skilled in the art will appreciate that all of these features in a standard hydraulic flexible hose are well known. In reference to the embodiment of FIG. 5, the retract volume 241 of hydraulic hoselinder 220 is empty and fluidly disconnected from the hydraulic circuit. Instead, the eye 231 of cylinder rod 230 is connected to a weight 80. When the hydraulic hoselinder 220 is oriented appropriately with respect to gravity, the weight 80 may act to bias the cylinder rod 230 toward the retracted position without reliance upon hydraulic fluid as in the embodiment of FIGS. 1-3 or a spring 170 as in the embodiment shown in FIG. 4. FIG. 6 shows the hoselinder 20 of FIG. 2 with an alternative retract strategy that includes an accumulator return 75 fluidly connected to the retract port 47. The accumulator return 75 includes a housing 76 that is divided into a hydraulic fluid volume 77 and a pressurized gas volume 79 by a movable piston 78. When the extend hydraulic volume 40 is fluidly connected to tank, the pressurized gas in gas volume 79 pushes on piston 78 to push hydraulic fluid from hydraulic fluid reservoir 77 into retract volume 41 to cause the cylinder rod 30 to retract. The pressurized gas also serves to bias the cylinder rod 30 toward the retracted position.

### INDUSTRIAL APPLICABILITY

The present disclosure finds general applicability in lighter duty hydraulic systems that may find advantage in substituting a hydraulic hoselinder of the present disclosure in place of a hydraulic cylinder of the prior art. Hydraulic hoselinders of the present disclosure could provide a low cost alternative to conventional hydraulic cylinders in a wide variety of hydraulic system applications.

Regardless of which hoselinder 20, 120 or 220 is utilized with hydraulic system 10 of FIG. 1, the extend hydraulic volume 40 will be fluidly connected to the outlet 14 of the hydraulic fluid pump 12 when the control valve 18 is in the extend configuration 37. The extend hydraulic volume 40 will be fluidly connected to the tank 11 when the control valve 18 is in the retract configuration 35. The extend hydraulic volume 40 is blocked from the hydraulic fluid pump 12 and the tank 11 when the control valve 18 is in the neutral configuration, as shown in FIG. 1. In the case of the embodiments shown in FIGS. 4 and 5, the retract volume 141, 241 is fluidly disconnected from the hydraulic circuit and relies on either a spring 170, or possibly the weight 80 of an attached piece in order to bias the cylinder rod 130, 230 toward the retracted position. In such a case, when it was time to retract, the hydraulic extend volume would be fluidly connected to tank 11 to facilitate retraction.

In the case of the embodiment shown in FIGS. 1-3, the retract hydraulic volume 41 is fluidly connected to the outlet 14 of hydraulic fluid pump 12 when the control valve 18 is in the retract configuration 35. The retract hydraulic volume 41 is fluidly connected to the tank 11 when the control valve 18 is in the extend configuration 37. The retract hydraulic volume 41 is blocked from the hydraulic fluid pump 12 and the tank 11 when the control valve 18 is in the neutral configuration 37, as shown.

A hydraulic hoselinder 20, 120, 220 of the present disclosure can provide a potentially low cost alternative to conventional hydraulic cylinders, especially where lower fluid pressures, a lighter duty of the specific application or other reasons known in the art permit a hydraulic hoselinder as an attractive alternative to the more costly hydraulic cylinders known in the art.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A hydraulic hoselinder comprising:
a hydraulic linear actuator integrated into a flexible hose;
the flexible hose having rigid fluid coupling mounted to one end with a first crimp collar and a rigid rod fitting mounted to an opposite end with a second crimp collar;
a cylinder rod extending through the rigid rod fitting and including a eye at one end and a piston that divides the flexible hose into an extend hydraulic volume and a retract volume, and the cylinder rod being movable along a straight line with respect to the rigid rod fitting between a retracted position and an extended position;
the rigid fluid coupling being located a distance from the rigid rod fitting along a central axis of the flexible hose, and the distance is greater than a length of the cylinder rod; and
a majority of an active length of the cylinder rod being positioned inside the flexible hose at the retracted position, and a majority of the active length of the cylinder rod being outside the flexible hose at the extended position.

2. The hoselinder of claim 1 wherein the retract volume is a retract hydraulic volume;
the rigid rod fitting includes a retract port fluidly connected to the retract hydraulic volume through a passage defined by the rigid rod fitting; and
a set of hydraulic cylinder seals positioned in an annular clearance between the cylinder rod and the rigid rod fitting.

3. The hoselinder of claim 1 wherein the rigid rod fitting includes an end fitting that defines a plurality of fastener bores that extend parallel to the central axis at a distance from the central axis that is greater than an outer diameter of the flexible hose;
an end cap in contact with the end fitting in a plane oriented perpendicular to the central axis, and including a plurality of fastener bores that align with the plurality of fastener bores of the end fitting;
a face seal positioned between, and in contact with, the end fitting and the end cap; and
a bolt extending through each pair of aligned fastener bores.

4. The hoselinder of claim 3 wherein the plurality of fastener bores of one, but not both, of the end fitting and the end cap are threaded to match the bolt; and
the bolt is longer than a combined length of the end fitting and the end cap so that a threaded segment of the bolt extends beyond one of the end fitting and the end cap when a head of the bolt is in contact with an other of the end fitting and the end cap.

5. The hoselinder of claim 4 wherein the retract volume is a retract hydraulic volume;
the rigid rod fitting includes a retract port fluidly connected to the retract hydraulic volume through a passage defined by the rigid rod fitting;
a set of hydraulic cylinder seals positioned in an annular clearance between the cylinder rod and the rigid rod fitting; and
one of the end fitting and the end cap defines the retract port.

6. The hoselinder of claim 4 including a spring operably positioned in the retract volume to bias the piston toward the retracted position.

7. The hoselinder of claim 1 including a spring operably positioned in the retract volume to bias the piston toward the retracted position.

8. The hoselinder of claim 1 including an accumulator return fluidly connected to the retract volume to bias the piston toward the retracted position.

9. A hydraulic system comprising:
a tank of hydraulic fluid;
a hydraulic fluid pump with an inlet fluidly connected to the tank;
a hydraulic circuit with a first end fluidly connected to an outlet of the hydraulic fluid pump and a second end opening into the tank;
a control valve positioned in the hydraulic circuit and being movable among a retract configuration, a neutral configuration and an extend configuration;
a hydraulic hoselinder with rigid fluid coupling fluidly connected to the hydraulic circuit, and the hydraulic hoselinder comprising:
a hydraulic linear actuator integrated into a flexible hose;
the flexible hose having the rigid fluid coupling mounted to one end with a first crimp collar and a rigid rod fitting mounted to an opposite end with a second crimp collar;
a cylinder rod extending through the rigid rod fitting and including a eye at one end and a piston that divides the flexible hose into an extend hydraulic volume and a retract volume, and the cylinder rod being movable along a straight line with respect to the rigid rod fitting between a retracted position and an extended position;
the rigid fluid coupling being located a distance from the rigid rod fitting along a central axis of the flexible hose, and the distance is greater than a length of the cylinder rod; and
a majority of an active length of the cylinder rod being positioned inside the flexible hose at the retracted position, and a majority of the active length of the cylinder rod being outside the flexible hose at the extended position.

10. The hydraulic system of claim 9 wherein the extend hydraulic volume is fluidly connected to the outlet of the pump when the control valve is in the extend configuration;
the extend hydraulic volume is fluidly connected to the tank when the control valve is in the retract configuration; and
the extend hydraulic volume is blocked from the pump and the tank when the control valve is in the neutral configuration.

11. The hydraulic system of claim 10 including a spring operably positioned in the retract volume to bias the piston toward the retracted position.

12. The hydraulic system of claim 10 wherein the retract volume is empty and fluidly disconnected from the hydraulic circuit.

13. The hydraulic system of claim 12 wherein the eye of the cylinder rod is attached to a weight; and
the hoselinder is oriented so that the weight biases the cylinder rod toward the retracted position.

14. The hydraulic system of claim 10 wherein the hoselinder includes a retract port fluidly connected to the hydraulic circuit, and the retract volume is a retract hydraulic volume;
the rigid rod fitting includes the retract port, which is fluidly connected to the retract hydraulic volume through a passage defined by the rigid rod fitting;
the retract hydraulic volume is fluidly connected to the outlet of the pump when the control valve is in the retract configuration;
the retract hydraulic volume is fluidly connected to the tank when the control valve is in the extend configuration;
the retract hydraulic volume is blocked from the pump and the tank when the control valve is in the neutral configuration; and
a set of hydraulic cylinder seals positioned in an annular clearance between the cylinder rod and the rigid rod fitting.

15. The hydraulic system of claim 14 wherein the rigid rod fitting includes an end fitting that defines a plurality of fastener bores that extend parallel to the central axis at distance from the central axis that is greater than an outer diameter of the flexible hose;
an end cap in contact with the end fitting in a plane oriented perpendicular to the central axis, and including a plurality of fastener bores that align with the plurality of fastener bores of the end fitting;
a face seal positioned between, and in contact with, the end fitting and the end cap; and
a bolt extending through each pair of aligned fastener bores.

16. The hydraulic system of claim 15 wherein the plurality of fastener bores of one, but not both, of the end fitting and the end cap are threaded to match the bolt; and
the bolt is longer than a combined length of the end fitting and the end cap so that a threaded segment of the bolt extends beyond one of the end fitting and the end cap when a head of the bolt is in contact with an other of the end fitting and the end cap.

17. The hydraulic system of claim 16 wherein one of the end fitting and the end cap defines the retract port.

18. The hydraulic system of claim 10 including an accumulator return fluidly connected to the retract volume to bias the piston toward the retracted position.
